(19) United States
(12) Patent Application Publication
(10) Pub. No.: US 2011/0171508 A1
(43) Pub. Date: Jul. 14, 2011

(54) SECONDARY BATTERY

(75) Inventor: Daekyu Kim, Yongin-si (KR)

(73) Assignee: Samsung SDI Co., Ltd., Yongin-si (KR)

(21) Appl. No.: 12/945,776

(22) Filed: Nov. 12, 2010

(30) Foreign Application Priority Data
Jan. 11, 2010 (KR) 10-2010-0002286

(51) Int. Cl. H01M 10/02; H01M 2/08

(52) U.S. Cl. 429/94; 429/185

(57) ABSTRACT

A secondary battery is disclosed. The secondary battery includes an electrode assembly formed by stacking and winding two different electrodes and a separator disposed between the electrodes, a can accommodating the electrode assembly, a cap assembly coupled to an upper portion of the can accommodating the electrode assembly, a gasket compressed between the cap assembly and the upper portion of the can to insulate and seal a space between the cap assembly and the can, and an auxiliary sealing member disposed inside the gasket to increase sealing force between the cap assembly and the can. The secondary battery maintains sealing force of the gasket closely contacting the outer surface of the cap assembly to secure sufficient sealing force and inhibit the dispersion of sealing pressures.

### CROSS-REFERENCE TO RELATED APPLICATION

This application claims the benefit of Korean Patent Application No. 10-2010-0002286, filed Jan. 11, 2010 in the Korean Intellectual Property Office, the disclosure of which is incorporated herein by reference.

### BACKGROUND

1. Field

Embodiments relate to a secondary battery.

2. Description of the Related Art

In general, secondary batteries are classified into cylinder type secondary batteries, prismatic type secondary batteries, and pouch type secondary batteries, according to the shape of a case accommodating an electrode assembly. Of these, a cylinder type secondary battery is assembled by inserting an electrode assembly in a cylinder type can, and then, by coupling a cap assembly to a top opening of the cylinder type can, so that the cap assembly is electrically connected to the electrode assembly to transmit a current to the outside.

A beading part is disposed in the top side end of the can to inhibit the electrode assembly from moving in the can. A gasket is disposed on the inner wall of the top opening of the can, so that parts can be seated on the gasket and coupled to the gasket, and the inner space of the battery can be sealed. The cap assembly is disposed inside the gasket to close the top opening of the can. Such a secondary battery undergoes a crimping process in which a cap-up coupled to the inner portion of a gasket is used as a cap to apply pressure to the inner and lower portions of a wall defining an top opening of a cylinder type can, so as to seal the can.

The insides of gaskets of secondary batteries are typically coated with tar for sealing and adhering. In this case, since uniform applying of tar is difficult, sealing performance may be degraded during a crimping process.

### SUMMARY

Aspects of the present invention provide a secondary battery that maintains sealing force of a gasket in close contact with the outer surface of a cap assembly, thus securing sufficient sealing force and inhibiting the dispersion of sealing pressures.

According to at least one embodiment, a secondary battery including: an electrode assembly formed by stacking and winding two different electrodes and a separator disposed between the electrodes; a can accommodating the electrode assembly; a cap assembly coupled to an upper portion of the can accommodating the electrode assembly; a gasket compressed between the cap assembly and the upper portion of the can to insulate and seal a space between the cap assembly and the can; and an auxiliary sealing member disposed inside the gasket to increase sealing force between the cap assembly and the can.

The gasket may include: a bent part disposed between the cap assembly and the upper portion of the can and bent when the gasket is compressed; an extension part extending toward a center axis of the gasket under the bent part; and a seat part disposed along a periphery of an inner top of the extension part, wherein the cap assembly is seated on the seat part, and the auxiliary sealing member is fixed to the seat part.

The seat part may have an insertion groove along an inner periphery, and the auxiliary sealing member may be inserted and fixed to the insertion groove.

The auxiliary sealing member may include a rubber ring having a circular cross section. The rubber ring may have a cross-sectional diameter t1 ranging from about 0.4 mm to about 0.8 mm. The rubber ring may have a ring outer diameter t2 ranging from about 15 mm to about 17 mm.

The insertion groove may have a depth ranging from about 40% to about 80% of a cross-sectional diameter of the rubber ring.

The auxiliary sealing member may be formed of elastic rubber-based material.

The auxiliary sealing member may include a portion protruding upward, and be integrally formed with the seat part. The auxiliary sealing member may be formed by injecting material of the auxiliary sealing member in an insertion groove disposed in the seat part.

The auxiliary sealing member may have a protrusion height ranging from about 20% to about 60% of a depth of the insertion groove of the seat part.

### BRIEF DESCRIPTION OF THE DRAWINGS

The above and other aspects and advantages will become more apparent to those of ordinary skill in the art by describing in detail exemplary embodiments with reference to the attached drawings, in which:

FIG. 1 is a cross-sectional view illustrating a secondary battery according to an embodiment;

FIG. 2 is an enlarged cross-sectional view illustrating a cap assembly of FIG. 1;

FIG. 3 is an enlarged view illustrating a portion III of FIG. 2;

FIG. 4 is a perspective view illustrating a gasket including an auxiliary sealing member according to an embodiment;

FIG. 5 is a cross-sectional view illustrating the gasket of FIG. 4;

FIG. 6 is a partial cut-away perspective view illustrating a gasket including an auxiliary sealing member according to an embodiment; and

FIGS. 7A and 7B are schematic views illustrating a process of crimping an upper end of a cylinder type can according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

Hereinafter, embodiments will be described in detail with reference to the accompanying drawings.

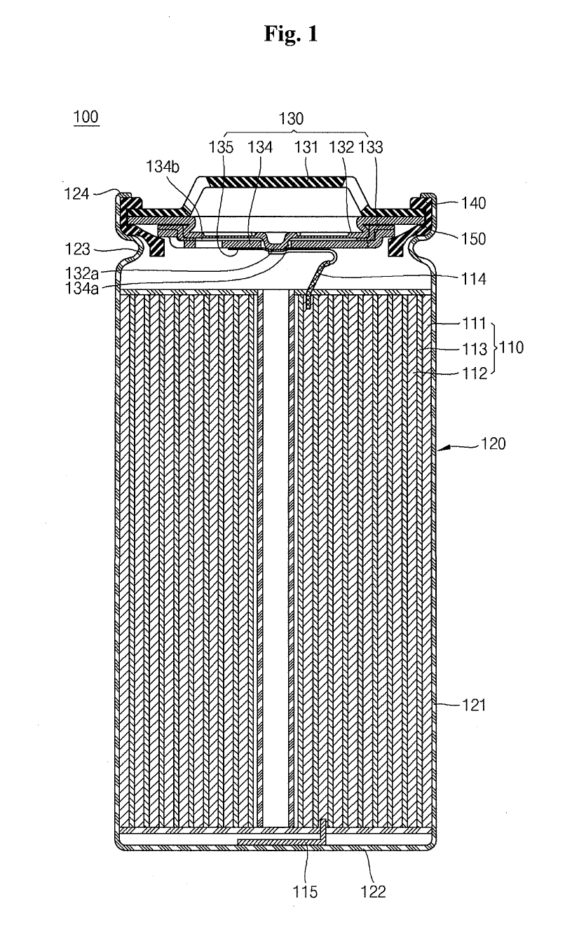

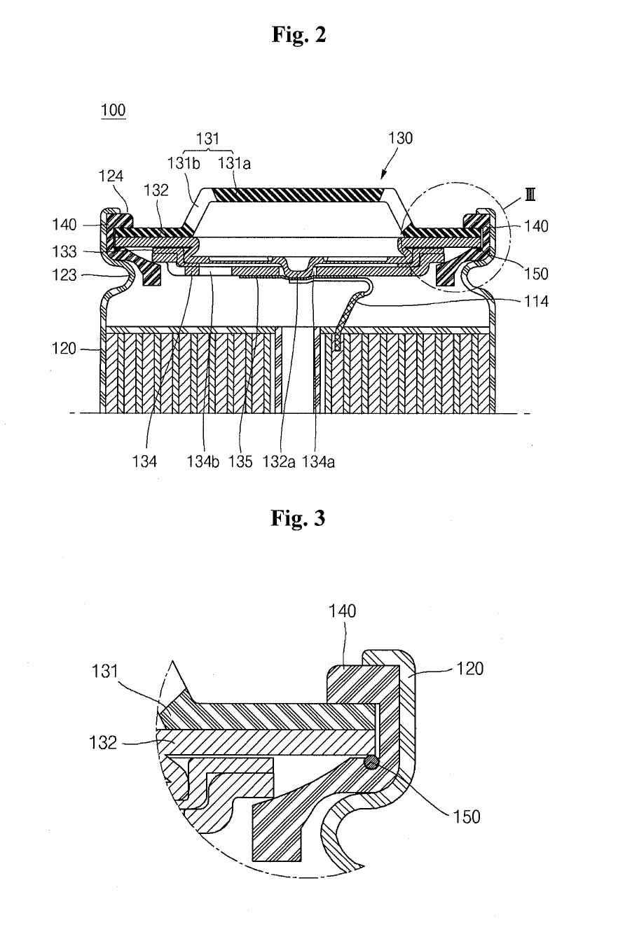

FIG. 1 is a cross-sectional view illustrating a secondary battery according to an embodiment. FIG. 2 is an enlarged cross-sectional view illustrating a cap assembly of FIG. 1. FIG. 3 is an enlarged view illustrating a portion III of FIG. 2.

Referring to FIGS. 1 through 3, a secondary battery 100 includes an electrode assembly 110, a cylinder type can 120 accommodating the electrode assembly 110, a cap assembly 130 coupled to a top opening of the cylinder type can 120 with the electrode assembly 110 inserted in the can 120, and a gasket 140 disposed on the inner surface of the top opening of the can 120, and an auxiliary sealing member 150 disposed inside the gasket 140. The cap assembly 130 is seated on the gasket 140.

The electrode assembly 110 may be formed by winding a positive electrode plate 111, a negative electrode plate 112, and a separator 113 in a jelly roll shape. The positive electrode plate 111 includes a positive electrode collector having a surface coated with a positive electrode coating portion. The negative electrode plate 112 includes a negative electrode collector having a surface coated with a negative electrode portion. The separator 113 is disposed between the positive electrode plate 111 and the negative electrode plate 112 to electrically insulating the positive electrode plate 111 and the negative electrode plate 112. At the upper side of the electrode assembly 110, a positive electrode tab 114 is connected to the cap assembly 130. At the lower side of the electrode assembly 110, a negative electrode tab 115 is connected to a bottom surface of the cylinder type can 120.

The positive electrode collector of the positive electrode plate 111 is formed of conductive metal to collect electrons from the positive electrode coating portion and move the electrons to an external circuit. The positive electrode coating portion is formed by mixing positive electrode active materials, conductive material, and binder, and has a constant thickness through coating on the positive electrode collector. The positive electrode plate 111 has positive electrode non-coating portions at both ends of the positive electrode collector without the positive electrode coating portion. The positive electrode tab 114 is welded to a side of the positive electrode non-coating portions.

The negative electrode collector of the negative electrode plate 112 is formed of conductive metal to collect electrons from the negative electrode coating portion and move the electrons to an external circuit. The negative electrode coating portion is formed by mixing negative electrode active materials, conductive material, and binder, and has a constant thickness through coating on the negative electrode collector. The negative electrode plate 112 has negative electrode non-coating portions at both ends of the negative electrode collector without the negative electrode coating portion. The negative electrode tab 115 is welded to a side of the negative electrode non-coating portions.

The separator 113 is disposed between the positive electrode plate 111 and the negative electrode plate 112, and may be extended to surround the outer surface of the electrode assembly 110. The separator 113 prevents a short circuit between the positive electrode plate 111 and the negative electrode plate 112, and is formed of porous high polymer through which lithium ions can pass.

The cylinder type can 120 includes a side surface plate 121 that is a cylinder body having a constant diameter to have a space for accommodating the electrode assembly 110, and a lower surface plate 122 that seals the lower portion of the side surface plate 121. The cylinder type can 120 may be formed of lightweight conductive metal such as aluminum or aluminum alloy, and be formed through a process such as deep drawing. The top opening of the cylinder type can 120 is open, and is closed after the electrode assembly 110 is inserted into it. A beading part 123 preventing the move of the electrode assembly 110 is disposed on the upper portion of the cylinder type can 120. The uppermost part of the cylinder type can 120 is provided with a crimping part 124 for fixing the cap assembly 130.

The cap assembly 130 includes a cap-up 131, a safety vent 132, a cap-down 134, an insulator 133 disposed between the safety vent 132 and the cap-down 134, and a sub plate 135 fixed to the lower surface of the cap-down 134. The cap-up 131 is electrically connected to the electrode assembly 110, and transmits a current generated from the electrode assembly 110 to the outside. The safety vent 132 has an upper surface closely contacting the lower surface of the cap-up 131, and cuts off a current and discharges inner gas when abnormal inner pressure is generated in the cylinder type can 120. The cap-down 134 is installed under the safety vent 132 to seal the inner space of the cylinder type can 120. The positive electrode tab 114 is attached to the sub plate 135.

The cap-up 131 is formed from a circular plate, and includes a terminal part 131a protruding at its center to be electrically connected to the outside. A plurality of gas exhausting holes 131b are disposed at the periphery of the terminal part 131a to exhaust gas generated in the cylinder type can 120.

The safety vent 132 is formed from a circular plate corresponding to the cap-up 131, and includes a protrusion part 132a protruding downward from its center.

The insulator 133 is disposed between the safety vent 132 and the cap-down 134 to electrically insulate the safety vent 132 and the cap-down 134.

The cap-down 134 is formed from a circular plate. The center of the cap-down 134 is provided with a through hole 134a through which the protrusion part 132a of the safety vent 132 passes. A side of the cap-down 134 is provided with a gas exhausting hole 134b through which gas raising the protrusion part 132a of the safety vent 132 is exhausted when excessive inner pressure is generated.

The sub plate 135 is welded to the protrusion part 132a of the safety vent 132 passing through the through hole 134a of the cap-down 134, to electrically connect the positive electrode tab 114 to the safety vent 132.

Although not shown, a positive temperature coefficient (PTC) device that is a secondary protective device may be installed between the cap-up 131 and the safety vent 132.

The cap-up 131 and the safety vent 132 are placed on an inner surface seat part of the gasket 140 installed on the top opening of the cylinder type can 120, so that the gasket 140 is closely coupled to the outer surface of the cap-up 131.

The gasket 140 is compressed and fixed between the cap assembly 130 and the upper portion of the cylinder type can 120. Accordingly, the gasket 140 seals and insulates the space between the cylinder type can 120 and the cap assembly 130, and also insulates the space between the electrode assembly 110 and the cap assembly 130. In addition, the gasket 140 absorbs a shock due to the electrode assembly 110 moved by dropping or vibration of the secondary battery 100, and advances the operation time of a current interrupt device (CID) operated when the secondary battery 100 is overcharged.

The auxiliary sealing member 150 is fixed to the inside of the gasket 140, and functions as an auxiliary member for improving sealing force between the cap assembly 130 and the cylinder type can 120. That is, the auxiliary sealing member 150 is in close contact with the outer bottom of the safety vent 132 of the cap assembly 130, so that the sealing force is greater than that of the case of using only the gasket 140. As such, the sealing force is increased to inhibit the leakage of electrolyte.

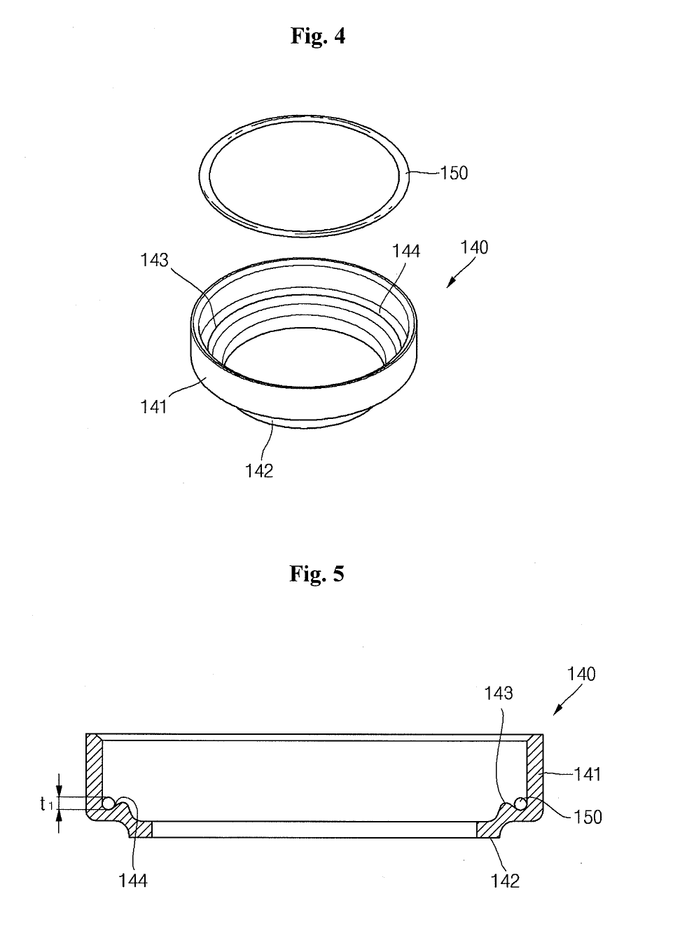

FIG. 4 is a perspective view illustrating a gasket including an auxiliary sealing member according to an embodiment. FIG. 5 is a cross-sectional view illustrating the gasket of FIG. 4.

FIGS. 1 through 5, the gasket 140 includes a bent part 141, an extension part 142, and a seat part 143. The auxiliary sealing member 150 is disposed inside the gasket 140.

The bent part 141 is bent in a crimping process of compressing the gasket 140 between the cap assembly 130 and the upper portion of the cylinder type can 120. When the gasket 140 is inserted in the inner surface of the top opening of the cylinder type can 120, the cap assembly 130 is placed on the gasket 140, and the upper end of the cylinder type can 120 is crimped. As such, when the upper end of the cylinder type can 120 is crimped, the bent part 141 of the gasket 140 is in close contact with the outer surface of the cap-up 131 and the outer surface of the safety vent 132, and applies a constant sealing force to the outer surfaces thereof.

The extension part 142 extends toward the center axis of the gasket 140 under the bent part 141. Before shock of a jelly roll or a center pin is applied to the safety vent 132 when the secondary battery 100 is dropped, the extension part 142 functions as a barrier against the shock.

The bent part 141 may be integrally formed with the extension part 142, and be formed of material absorbing shock of the electrode assembly 110 or the center pin when the secondary battery 100 is dropped or vibrated. The bent part 141 and the extension part 142 may be formed of material insulating the space between the electrode assembly 110 and the cap assembly 130. For example, the bent part 141 and the extension part 142 may be formed of material that does not react with electrolyte. Such material may be any one forming the gasket 140 in the art, for example, may be polypropylene.

The seat part 143 is disposed along the periphery of the inner top of the extension part 142, and the cap assembly 130 is seated on the seat part 143. Specifically, the side end of the bottom surface of the safety vent 132 constituting the cap assembly 130 is seated on the seat part 143.

For example, the seat part 143 has an insertion groove 144 along its inner periphery. The auxiliary sealing member 150 may be inserted and fixed to the insertion groove 144.

The auxiliary sealing member 150 is an auxiliary member for improving the sealing force of the gasket 140.

The auxiliary sealing member 150 may be a rubber ring having a circular cross section. For example, the auxiliary sealing member 150 may be inserted and fixed to the insertion groove 144 disposed along the inner periphery of the seat part 143. In this case, the insertion groove 144 may have a depth ranging from about 40% to about 80% of the cross-sectional diameter of the rubber ring used as the auxiliary sealing member 150. When the depth of the insertion groove 144 is less than about 40% of the cross-sectional diameter of the rubber ring, the rubber ring may be loosely fixed to the insertion groove 144. When the depth of the insertion groove 144 is greater than about 80% of the cross-sectional diameter of the rubber ring, a portion of the auxiliary sealing member 150 protruding outward is decreased, so that the auxiliary performance for improving the sealing force may be degraded. Thus, the depth of the insertion groove 144 may range from about 40% to about 80% of the cross-sectional diameter of the auxiliary sealing member 150.

The rubber ring used as the auxiliary sealing member 150 may be formed of any elastic rubber-based resin used for sealing. The rubber ring may have a cross-sectional diameter t1 ranging from about 0.4 mm to about 0.8 mm. For example, the cross-sectional diameter t1 of the rubber ring may be about 0.5 mm. The rubber ring used as the auxiliary sealing member 150 may have a ring outer diameter t2 ranging from about 15 mm to about 17 mm. For example, the ring outer diameter t2 of the rubber ring may be about 16.4 mm. However, since it is obvious to those skilled in the art that the ring outer diameter and the cross-sectional diameter of the rubber ring may be varied considering the size of the gasket 140 and the width of the seat part 143, the ring outer diameter and the cross-sectional diameter of the rubber ring may be varied within the scope of the present disclosure.

For example, the rubber ring may be formed of nitril butadiene rubber (NBR).

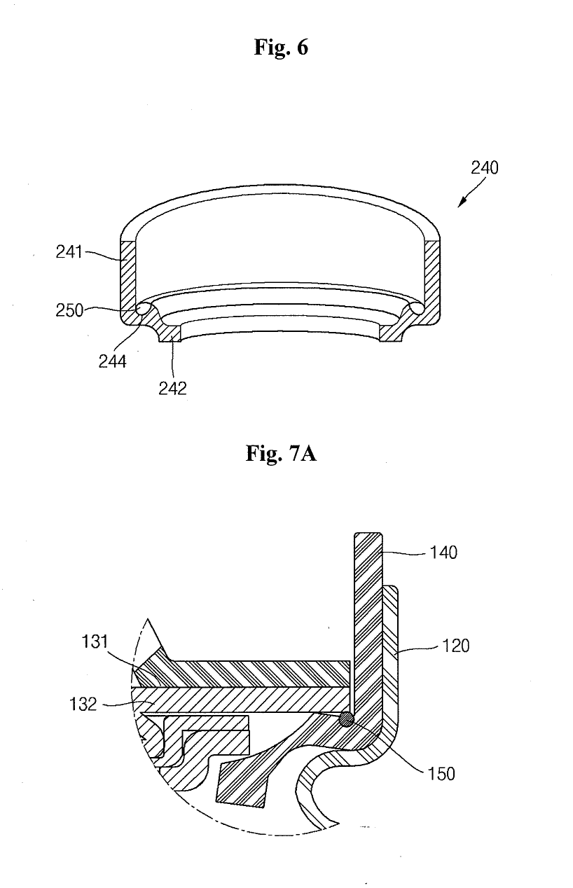

FIG. 6 is a partial cut-away perspective view illustrating a gasket including an auxiliary sealing member according to another embodiment.

Referring to FIG. 6, a gasket 240 includes a bent part 241, an extension part 242, and a seat part 243. An auxiliary sealing member 250 has a portion protruding upward, and is integrally formed with the seat part 243.

Since the bent part 241, the extension part 242, and the seat part 243 of the gasket 240 are the same as those of the previous embodiment, a description thereof will be omitted.

According to the current embodiment, the auxiliary sealing member 250 including the protruding portion is integrally formed with the seat part 243 of the gasket 240, unlike the previous embodiment in which the auxiliary sealing member is inserted into the insertion groove disposed in the seat part of the gasket.

The auxiliary sealing member 250 including the portion protruding upward may be integrally formed with the seat part 243 by using one of various methods. For example, a double injection method using different types of resin may be used. That is, when the gasket 240 is formed through injection, the material of the auxiliary sealing member 250 is simultaneously injected inside the seat part 243 of the gasket 240, so that the auxiliary sealing member 250 including the portion protruding upward is integrally formed with the seat part 243 of the gasket 240. In this case, the auxiliary sealing member 250 may be formed of elastic rubber that is different from the material of the gasket 240.

For example, when the gasket 240 is formed through injection, a groove 244 is formed in the seat part 243, and material of the auxiliary sealing member 250 is injected in the groove 244, so that the auxiliary sealing member 250 including the portion protruding upward is integrally formed with the seat part 243 of the gasket 240. As such, when the gasket 240 is integrally formed with the auxiliary sealing member 250, a process of forming an insertion groove in the seat part 243, and a process of inserting and fixing an auxiliary sealing member into the insertion groove may be removed to improve the productivity.

As described above, when the material of the auxiliary sealing member 250 is injected into the groove 244 of the seat part 243 to integrally form the auxiliary sealing member 250 including the portion protruding upward with the seat part 243, the protruding portion may have a protrusion height ranging from about 20% to about 60% of the depth of the groove 244 of the seat part 243 to improve the sealing force.

A process of fabricating a secondary battery according to an embodiment will now be described with reference to FIGS. 1 through 3.

To assemble the secondary battery, the electrode assembly 110 is inserted into the cylinder type can 120, electrolyte is injected in the cylinder type can 120, and then, the top opening of the cylinder type can 120 is sealed with the cap assembly 130.

The cap-up 131 and the safety vent 132 is assembled, and then, the cap assembly 130 is assembled in the state where the insulator 133 is disposed on the upper portion of the cap-down 134. That is, the protrusion part 132a passes through the through hole 134a of the cap-down 134 to couple the safety vent 132 to the cap-down 134, and the sub plate 135 is welded to the protrusion part 132a of the safety vent 132.

After the electrode assembly 110 is inserted in the cylinder type can 120, and the electrolyte is injected in the cylinder type can 120, the beading part 123 for preventing the move of the electrode assembly 110 is formed in the upper portion of the cylinder type can 120. Then, the gasket 140 including the auxiliary sealing member 150 is inserted in the inner surface of the top opening of the cylinder type can 120, the cap assembly 130 is seated on the gasket 140, and then, the upper end of the cylinder type can 120 is crimped.

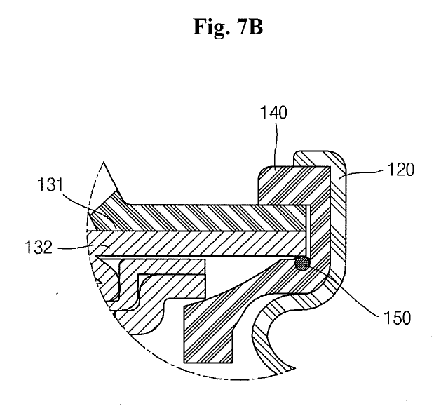

FIGS. 7A and 7B are schematic views illustrating a process of crimping an upper end of a cylinder type can according to an embodiment.

Referring to FIG. 7A, to perform the crimping process, the gasket 140 including the auxiliary sealing member 150 is inserted in the inner surface of the top opening of the cylinder type can 120, and then, the cap assembly 130 is seated on the gasket 140.

Thereafter, the upper end of the cylinder type can 120 is crimped. Thus, the bent part 141 of the gasket 140 applies a constant sealing force to the outer surfaces of the cap-up 131 and the safety vent 132, and is in close contact with the outer surfaces, as illustrated in FIG. 7B. At this point, the auxiliary sealing member 150 is in close contact with the side end of the bottom surface of the safety vent 132, so that the sealing force is greater than that in the case of using only the gasket 140, and the dispersion of sealing forces is inhibited.

### EXPERIMENTAL EXAMPLE

To measure sealing pressures according to the presence of an auxiliary sealing member, secondary batteries configured as illustrated in FIG. 1 were assembled. A gasket configured illustrated in FIG. 4 was used in an embodiment, and a related art gasket without an auxiliary sealing member was used in a comparison example, instead of using the gasket configured illustrated in FIG. 4.

Holes were formed in cans of the assembled secondary batteries, and then, nitrogen was put into the cans through the holes. At this point, soap bubbles were applied on relevant portions of the secondary batteries to measure a sealing pressure at a time point when air bubbles were generated. This process was repeated three times. The results are shown in Table 1.

TABLE 1

| | Embodiment | Comparison Example |
|---|---|---|
| First Sealing Pressure (kgf/cm²) | 30.20 | 9.80 |
| Second Sealing Pressure (kgf/cm²) | 29.80 | 13.40 |
| Third Sealing Pressure (kgf/cm²) | 30.30 | 10.70 |
| Mean Sealing Pressure (kgf/cm²) | 30.20 | 11.30 |

As shown in Table 1, the sealing pressures of the embodiment in which the gasket and the o-ring type auxiliary sealing member were used is significantly higher that those of the comparison example in which the auxiliary sealing member was not used.

The secondary battery according to the embodiments includes the auxiliary sealing member inside the gasket to increase sealing force, so that the gasket is in close contact with the outer surfaces of the cap-up and the safety vent to secure sufficient sealing force without applying tar, and the dispersion of sealing pressures can be inhibited.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A secondary battery comprising:
an electrode assembly formed by stacking and winding two different electrodes and a separator disposed between the electrodes;
a can accommodating the electrode assembly;
a cap assembly coupled to an upper portion of the can accommodating the electrode assembly;
a gasket compressed between the cap assembly and the upper portion of the can to insulate and seal a space between the cap assembly and the can; and
an auxiliary sealing member disposed inside the gasket to increase sealing force between the cap assembly and the can.

2. The secondary battery as claimed in claim 1, wherein the gasket comprises:
a bent part disposed between the cap assembly and the upper portion of the can and bent when the gasket is compressed;
an extension part extending toward a center axis of the gasket under the bent part; and
a seat part disposed along a periphery of an inner top of the extension part,
wherein the cap assembly is seated on the seat part, and the auxiliary sealing member is fixed to the seat part.

3. The secondary battery as claimed in claim 2, wherein the seat part has an insertion groove along an inner periphery, and the auxiliary sealing member is inserted and fixed to the insertion groove.

4. The secondary battery as claimed in claim 3, wherein the auxiliary sealing member comprises a rubber ring having a circular cross section.

5. The secondary battery as claimed in claim 3, wherein the auxiliary sealing member comprises a rubber ring, and the insertion groove has a depth ranging from about 40% to about 80% of a cross-sectional diameter of the rubber ring.

6. The secondary battery as claimed in claim 1, wherein the auxiliary sealing member is formed of elastic rubber-based material.

7. The secondary battery as claimed in claim 1, wherein the auxiliary sealing member is formed of rubber-based material.

8. The secondary battery as claimed in claim 2, wherein the auxiliary sealing member is integrally formed with the seat part and a portion of the auxiliary sealing member is protruded above the seat part.

9. The secondary battery as claimed in claim 8, wherein the auxiliary sealing member is formed by injecting material of the auxiliary sealing member in a groove disposed in the seat part.

10. The secondary battery as claimed in claim 8, wherein the protruded portion of the auxiliary sealing member has a height ranging from about 20% to about 60% of a depth of the insertion groove of the seat part.

11. A secondary battery comprising:
an electrode assembly;
a can that receives the electrode assembly;
a cap assembly coupled to an upper potion of the can that receives the electrode assembly;
a gasket interposed between the cap assembly and the upper portion of the can to seal a space between the cap assembly and the can; and
a sealing member positioned on the gasket so as to extend outward therefrom and engage with the cap assembly to increase the sealing between the cap assembly and the gasket.

12. The secondary battery of claim 11, wherein the gasket comprises
a bent part disposed between the cap assembly and the upper portion of the can and bent when the gasket is compressed;
an extension part extending toward a center axis of the gasket under the bent part;
a seal part disposed along a periphery of an inner top of the extension part wherein the cap assembly is seated on the seal part and the sealing member extends outward from the seat part.

13. The secondary battery of claim 12, wherein the seat part includes an insertion groove and the sealing member is inserted and fixed to the insertion groove.

14. The secondary battery of claim 12, wherein the sealing member comprises a rubber ring and the insertion groove has a depth ranging from about 40% to about 80% of the cross-sectional diameter of the rubber ring.

15. The secondary battery of claim 13, wherein the sealing member is integrally formed with the seat part so as to extend upward therefrom.

16. The secondary battery of claim 15, wherein the sealing member has a protrusion height ranging from about 20% to about 60% of the depth of the insertion groove of the seat part.
